(19) United States
(12) Patent Application Publication
(10) Pub. No.: US 2025/0205616 A1
(43) Pub. Date: Jun. 26, 2025

(54) METHOD FOR CONTINUOUS MONITORING OF EXTRACTION PROCESS

(71) Applicant: Schlumberger Technology Corporation, Sugar Land, TX (US)

(72) Inventors: Jason Milne, Perth (AU); Rod William Shampine, Sugar Land, TX (US)

(21) Appl. No.: 18/991,898

(22) Filed: Dec. 23, 2024

Related U.S. Application Data
(60) Provisional application No. 63/613,850, filed on Dec. 22, 2023.

(51) Int. Cl. B01D 15/10; B01D 15/42; C22B 3/02; C22B 3/24; C22B 26/12

(52) U.S. Cl. CPC B01D 15/102; B01D 15/424; C22B 3/02; C22B 3/24; C22B 26/12

(57) ABSTRACT

Continuous monitoring of density in extraction and recovery using pressure density sensors is described herein. Metal recovery methods and processes using pressure density sensors are also described herein. A method comprises providing an aqueous material containing target ions to a direct extraction unit; extracting target ions from the aqueous material containing target ions using a selective withdrawal medium to yield an extract and a depleted material; using a pressure density sensor to determine a first density of the aqueous material containing target ions; using a pressure density sensor to determine a second density of the depleted material; comparing the first density with the second density; and operating the direct extraction unit based on the comparison.

### FIELD

This patent application describes methods and apparatus for recovery of an element of interest from aqueous sources. Specifically, processes and apparatus for monitoring a lithium recovery process are described but may be applicable for recovery of any other element of interest.

### BACKGROUND

Metals are valuable commodities. Demand for metals continuously increases for their physical, chemical, and electrical properties. Lithium is a prime example.

Lithium is a key element in energy storage. Electrical storage devices, such as batteries, supercapacitors, and other devices commonly use lithium to mediate the storage and release of chemical potential energy as electrical current. As demand for renewable, but non-transportable, energy sources such as solar and wind energy grows, demand for technologies to store energy generated using such sources also grows.

According to the United States Geological Survey, global reserves of lithium total 26 million tons (metric) of lithium content, with Chile, Australia, Argentina, and China accounting for about 78% of global reserves. U.S. Geological Survey, Mineral Commodity Summaries, January 2023. Reuters reports that lithium supply is forecast to be 964 KT LCE in 2023, up from 737 KT in 2022. According to S&P Global Commodity Insights, lithium demand is expected to outpace supply by 3% in 2023, and every year thereafter until 2027. By 2028, global lithium demand is expected to double to over 2,000 kTa, while production is set to rise to 2,100 kTa. While lithium prices are quite volatile as the global market develops, lithium prices are expected to remain high through 2030. The incentive for more lithium production could not be clearer.

Manufacturers are exploring direct extraction methods of recovering elements of interest, in particular metals, including lithium, from aqueous sources. Such extraction methods typically involve contacting an aqueous source having metal ions with a selective medium that withdraws target ions from the aqueous source into the medium. The ion-loaded medium is then contacted with a material that removes the ions from the medium. The selective withdrawal medium can be liquid or solid, and the material that removes the ions from the selective withdrawal medium is typically an aqueous medium that can be pure water or water with acid, base, salt, or combination thereof. Ions removed from the selective withdrawal medium can then be processed into any convenient form, such as salts. In the example of lithium, extracted lithium can be converted into lithium carbonate or lithium hydroxide for battery applications. The extraction method described above in an exemplary one. Other extraction methods for selectively recovering metal ions, such as electrochemical separation, are also used.

Direct extraction processes generally rely on monitoring the extraction process to determine when the selective withdrawal medium is loaded or unloaded to an extent that processing can switch from loading to unloading, or vice versa. The process is also monitored to assess performance of the selective withdrawal medium so that reduction in performance can be remediated. Currently, continuous methods of monitoring extraction processes, and performance of selective withdrawal media, do not reliably report lithium content, or content of other ions of interest. Such content is conventionally monitored using manual analyses that are time consuming and subject to variable error. Continuous monitoring methods that can reliably report, or be used to control, content of metal ions such as lithium, are needed for monitoring of aqueous recovery processes.

### SUMMARY

Embodiments described herein provide a method of extracting target ions, comprising providing an aqueous material containing target ions to a direct extraction unit; extracting target ions from the aqueous material containing target ions using a selective withdrawal medium to yield an extract and a depleted material; using a pressure density sensor to determine a first density of the aqueous material containing target ions; using a pressure density sensor to determine a second density of the depleted material; comparing the first density with the second density; and operating the direct extraction unit based on the comparison.

Other embodiments described herein provide a method of extracting metal ions from an aqueous source, the method comprising obtaining an aqueous material bearing a target metal ion from an aqueous source; contacting the aqueous material with a selective withdrawal medium in a direct extraction unit to withdraw a target metal ion from the aqueous material to the selective withdrawal medium and form an ion-depleted aqueous material; using a pressure density sensor to determine a first density of the aqueous material; using a pressure density sensor to determine a second density of the ion-depleted aqueous material; comparing the first density with the second density; discontinuing contacting the aqueous material with the selective withdrawal medium based on the comparison; and after discontinuing contacting the aqueous material with the selective withdrawal medium, contacting an eluent with the selective withdrawal medium to remove target metal ions from the selective withdrawal medium and form an extract.

Other embodiments described herein provide a method, comprising extracting target ions from an aqueous metal-bearing material in an extraction stage to form an extract; transforming the extract into a product in a processing stage; using a pressure density sensor to determine a change in density of the aqueous metal-bearing material; and controlling operation of the extraction stage, the processing stage, or both, based on the change in density.

### BRIEF DESCRIPTION OF THE DRAWINGS

FIGS. 1A, 1B, and 1C are schematic elevation views of embodiments of pressure density sensors.

FIG. 2 is a flow diagram summarizing a method of obtaining a substantially continuous reading of a difference in target ion concentration between two aqueous materials according to one embodiment.

FIG. 3 is a flow diagram summarizing a method of determining lithium content of an aqueous stream where content of lithium and other species change with time according to another embodiment.

FIG. 4 is a flow diagram summarizing a method of recovering lithium from an aqueous source according to another embodiment.

FIG. 5 is a process flow diagram of a lithium recovery process that uses pressure sensors to provide substantially continuous target ion concentration readings, according to one embodiment.

FIG. 6 is a flow diagram summarizing a method of extracting lithium from an aqueous lithium containing material, according to one embodiment.

### DETAILED DESCRIPTION

It has been discovered that pressure sensors of sufficient precision can be incorporated in a pressure density sensor that can be used to monitor density, concentration of metal ions, or both, of aqueous streams with high accuracy and precision. Sensors that reliably report concentration of other species can be used to supplement measurements by pressure density sensors to improve accuracy of composition reporting by such devices.

Measuring pressure at the bottom of a fluid column of known volume can provide a measure of density of the fluid. Density of an aqueous medium varies with ion content, so ion content, or total dissolved solid, can be ascertained in some cases from measurement of the density of the fluid. For example, the following solutions of lithium chloride in water have the indicated densities at 21° C.:

| Total Dissolved Solids (TDS, ppm) | Density (g/mL) |
|---|---|
| 110,000 | 1.0864 |
| 100,000 | 1.075 |
| 10,000 | 1.0006 |
| 100 | 0.998 |

A properly configured and calibrated pressure density sensor of sufficient precision, configured to measure pressure at the bottom of a fluid column of known volume, can detect these density differences.

To measure lithium content using such a device, a column of fluid of known height can be arranged with a pressure sensor at the bottom of the fluid column and the pressure at the bottom of the fluid column can be measured. Density p of the fluid is proportional to the measured pressure and inversely proportional to the height of the fluid column according to the well-known equation: ρ=P/(l·g), where P is the measured pressure, l is the height of the fluid column and g the gravitational constant. Measuring pressure with sufficient precision, and knowing the height of the fluid column with similar precision, enables resolving density differences that can be used to infer and track concentration of ions in an aqueous fluid. The pressure device can be a precision pressure instrument, such as a piezoelectric pressure device or a quartz resonator sensor, both commonly used in measurement of pressure.

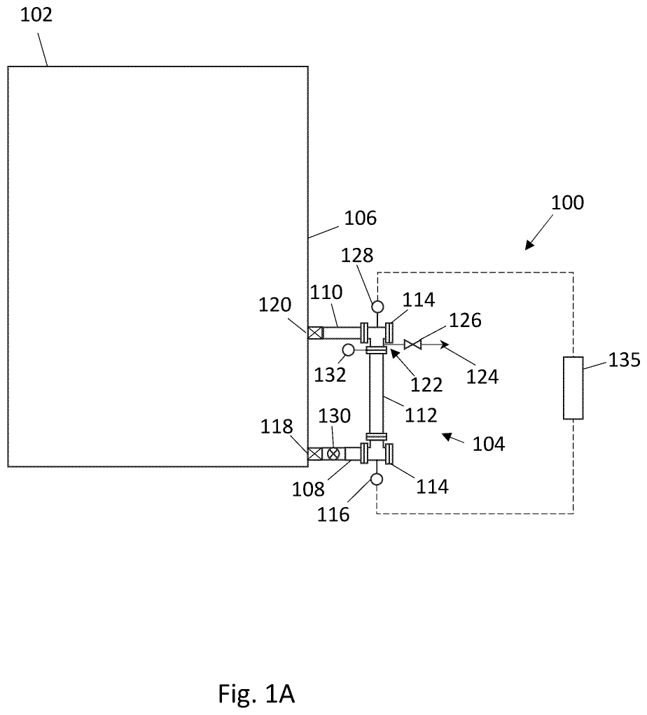

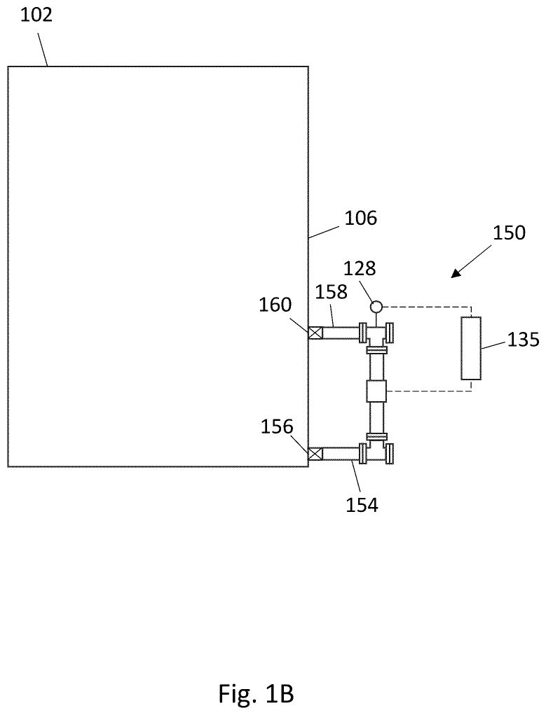

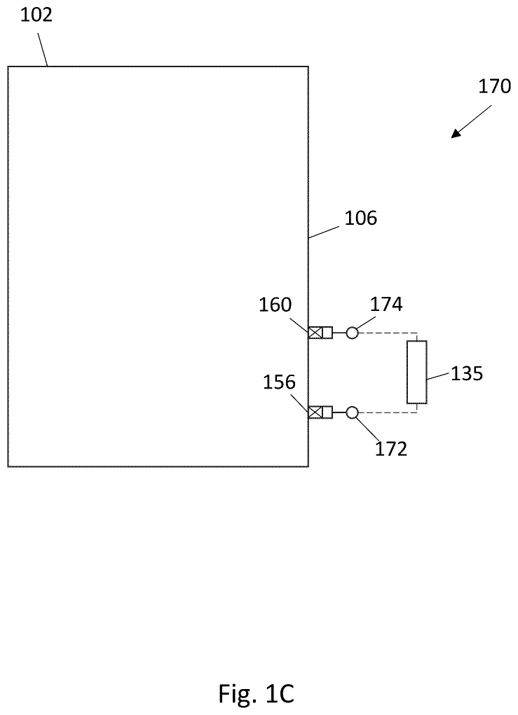

FIG. 1A is a schematic elevation view of a pressure density sensor 100 according to one embodiment. A vessel 102 contains a fluid for which density is to be measured. The pressure density sensor 100 includes a conduit 104 coupled to a wall 106 of the vessel 102. The vessel 102 can be a tank, having a relatively still volume of fluid inside, or a pipe that contains a flowing or stationary fluid. The conduit 104 has inlet 108 and outlet 110 coupled to the wall 106 and arranged vertically, such that a vertical line can be drawn from the center of the inlet 108 to the center of the outlet 110. The conduit 104 includes a vertical pipe section 112 of known length. The inlet 108 and outlet 110 connect to the vertical pipe section 112 using right-angle couplings 114 so that, as much as possible, a column of fluid within the vertical pipe section 112 has substantially constant height along all radii of the vertical pipe section 112.

The pressure density sensor 100 includes a pressure sensor 116 disposed at the bottom of the vertical pipe section 112, for example attached at the bottom of the right-angle coupling 114 coupling the vertical pipe section 112 to the inlet 108, in sensory engagement with the fluid in the vertical pipe section 112. The pressure sensor 116 can be, for example, a piezoelectric sensor that senses displacement of a membrane due to fluid pressure in the vertical pipe section 112, or a quartz resonator device that senses effect of fluid pressure in the vertical pipe section 112 on resonant frequency of a quartz crystal.

An inlet block valve 118 can be used to close the inlet 108 and an outlet block valve 120 can be used to close the outlet 110, to isolate the fluid column in the vertical pipe section 112 from fluid pressure in the vessel 102. A pressure relief opening 122 can be provided in the vertical pipe section 112 to relieve excess fluid pressure in the vertical pipe section 112. The pressure relief opening 122 can be provided at any elevation of the vertical pipe section 112, but providing the pressure relief opening 122 at a high elevation of the vertical pipe section 112 provides more fluid column for measurement, and incrementally more accuracy for the measurement. In one example, the pressure relief opening 122 can be provided at the top of the fluid column in the vertical pipe section 112, such as in the right-angle coupling 114 that couples the vertical pipe section 112 to the outlet 110. A pressure relief conduit 124 can be coupled to the pressure relief opening 122 with a pressure relief valve 126. After closing the inlet and outlet block valves 118 and 120, the pressure relief valve 126 can be opened to vent fluid from the vertical pipe section 112, leaving only fluid column pressure in the vertical pipe section 112. The pressure relief valve 126 may be left open while a pressure measurement is taken to avoid pressure building within the vertical pipe section 112 due to thermal changes.

The height of the fluid column in the vertical pipe section 112 above the pressure sensor 116 can be known with great precision. While the pressure relief valve 126 is open, any fluid above a meniscus level over the floor (bottom-most) location of the pressure relief opening 122 will flow out of the vertical pipe section 112. The pressure density sensor 100 can include a temperature sensor 128 to allow thermal effects on length of the vertical pipe section 112 to be computed and known. The temperature sensor 128 is shown here adjacent to a top of the fluid column, but the temperature sensor 128 could be adjacent to, or part of, the pressure sensor 116. In this way, height of the fluid column above the pressure sensor 116 can be known to great precision. From the known fluid height and the measured pressure, density of the fluid in the vertical pipe section 112, and therefore in the vessel 102, can be inferred.

The pressure density sensor 100 works best when the vessel 102 contains enough fluid to completely cover the outlet 110, such that the pressure density sensor 100 is fluid-filled when a measurement is taken. Alternately, a pump 130 can be coupled in the inlet 108, between the inlet 108 and the right-angle coupling 114, to pump fluid from the vessel 102 through the pressure density sensor 100 and back into the vessel 102. To take a measurement, the inlet 108 and outlet 110 can be opened and the pump 130 activated to fill the pressure density sensor 100 with fluid, which circulates through the inlet 108, vertical pipe section 112, and outlet 110 back into the vessel 102 while the pump 130 operates. To take a measurement, while the pump 130 is operating, the inlet 108 can be closed, and then the pump 130 can be deactivated. Fluid stops flowing within the pressure density sensor 100, and any fluid above the floor of the outlet 110 flows into the vessel 102, leaving a fluid column of known height in the vertical pipe section 112 for pressure measurement and density inference.

A digital processing unit 135 can be operatively coupled to the pressure density sensor 100 to resolve the density of the fluid in the vertical pipe section 112 using signals from the pressure sensor 116, and optionally using signals from the temperature sensor 128 as well. The digital processing unit 135 can also be operatively coupled to the pump 130, and to any other control devices such as control valves, to operate as a controller for the pressure density sensor 100. The controller 135 can be configured to compute density of the fluid in the vertical pipe section 112, ion concentration of the fluid in the vertical pipe section 112, or both.

It should be noted here that, where the outlet 110 does not experience pressure from a fluid column within the vessel 102, a density measurement can be performed while the pump 130 is operating and circulating fluid through the pressure density sensor 100, so long as the pump 130 maintains the vertical pipe section 112 and outlet 110 in a liquid-full state.

To improve readings, the pressure density sensor 100 can include a level sensor 132 to sense the top of the fluid column in the vertical pipe section 112. The level sensor 132 can be a type of sensor known in the art to have high accuracy and precision so that a precise reading of height of the fluid column can be obtained and used by the controller 135 to determine fluid density.

The pressure density sensor 100 is an absolute pressure system, meaning that pressure of the fluid column in the vertical pipe section 112 is measured relative to atmospheric pressure. A pressure density sensor can be used that measures pressure of the fluid column in the vertical pipe section 112 by reference to a known fluid column.

FIG. 1B is a schematic elevation view of a pressure density sensor 150 according to another embodiment. The pressure density sensor 150 is similar in most respects to the pressure density sensor 100, except that a differential pressure sensor 152 is used to obtain pressure at the bottom of a fluid column. Here, the differential pressure sensor 152 is fluidly connected to a first fluid conduit 154 coupled to the vessel 102 at a first location 156 and a second fluid conduit 158 coupled to the vessel 102 at a second location 160. The first and second locations 156 and 160 are displaced vertically so that fluid within the vessel 102 is sampled at two different elevations. The differential pressure sensor 152 has two diaphragms, each diaphragm closing the end of one of the fluid conduits 154 and 158, for instance where the conduit is coupled to the vessel 102. A reference fluid is disposed between the two diaphragms. A displacement sensor is coupled to each diaphragm to measure displacement of the diaphragms, which can be related to differences in pressure of the fluid in the vessel and the reference fluid, respectively in the first and second fluid conduits 154 and 158. The differential pressure between the two different vertical locations may therefore be derived, enabling to derive the density of the fluid.

Flushing apparatus, not shown, can be provided to flush the first and second fluid conduits 154 and 158 as needed. The temperature sensor 128 can be included as a separate sensor and/or as a part of the differential pressure sensor 152, and the controller 135 can be operatively coupled to the differential pressure sensor 152 to determine differences in pressure and fluid density based on signals from the differential pressure sensor 152. The controller 135 can also be operatively coupled to the temperature sensor 128 to determine, and compensate for, temperature effects on fluid density. The differential pressure sensor 152 may also include a temperature sensor to measure temperature of the reference fluid. The controller 135 can be further configured to normalize positions of the two diaphragms based on thermal changes in the reference fluid.

The pressure density sensors 100 and 150 can be calibrated using fluids of known composition and density, at different fluid temperatures and ambient temperatures, to ascertain a calibration relation. The calibration relation can be a linear equation, with proportionality constants determined by regression, or other statistical treatment, or the calibration relation can be a table, like the table above, in which density and concentration can be interpolated. In many cases, properly calibrated pressure density sensors such as the sensors 100 and 150 can have error rate of no more than about 0.002%. In some cases, the pressure density sensors have error rate no more than about 0.0002%, for example error rate of no more than about 0.000002 g/mL. Such high resolution density sensors can be used to ascertain the fine changes in density that accompany changes in composition of an aqueous fluid.

FIG. 1C is a schematic elevation view of a pressure density sensor 170 according to another embodiment. In this embodiment, two independent pressure sensors are coupled to the vessel 102 at different vertical locations. The difference in readings of the two sensors is interpreted, and density of the fluid between the two sensors is determined from the difference in readings. A first pressure sensor 172 is coupled to the vessel 102 at a first location 156 and a second pressure sensor 174 is coupled to the vessel 102 at a second location 160. To maximize accuracy and precision of the density determination, the first and second pressure sensors 172 and 174 are typically the same type, or similar type, so that drifts and thermal effects will be at least similar for the two devices. Each of the first and second pressure sensors 172 and 174 may include a temperature sensor, or alternately a temperature sensor may be coupled to the vessel 102 adjacent to each of the pressure sensors 172 and 174. The controller 135 is operatively coupled to each of the pressure sensors 172 and 174, and is configured to receive and interpret signals from the pressure sensors 172 and 174 and to compute a density of the fluid within the vessel 102 based on the signals. The controller 135 may be configured to use temperature readings at the locations 156 and 160 to compute thermal effects on density of the fluid within the vessel 102 and optionally to compute thermal effects on distance between the first and second pressure sensors 172 and 174.

The embodiments of FIG. 1A-C are exemplary embodiments but additional elements may be included in the system as per the disclosure.

The pressure density sensors 100, 150, 170 can be configured to provide flow of a fluid from the vessel 102 through the pressure density sensor 100, 150, 170 to stabilize composition of fluids in the pressure density sensor 150 and ensure representative measurement. Flow through the pressure density sensor 150 would typically be stopped, and the fluids allowed to become quiescent, before capturing a measurement.

Furthermore, the systems of FIG. 1A-1C configured to sample the fluid in the pressure sensor may include different flushing devices in order to flush the sample from the pressure sensor after the pressure measurement has been performed. Flushing is indeed an important feature so that a first sample (taken at a first time) does not mix with a second sample taken at a second, later, time and that the density of the second sample may be measured accurately. A flushing device may include one or more check valves to favor a fluid flow behavior when flushing the sample after measurement. A flushing device may also include backpressure control device such as a backpressure regulator in a line for flushing the sample after measurement. A flushing device may include a lower pressure discharge point. In an embodiment, the pressure sensor may include a PD plunger mechanism (similar to a triplex pump) to fill and empty the pressure sensor.

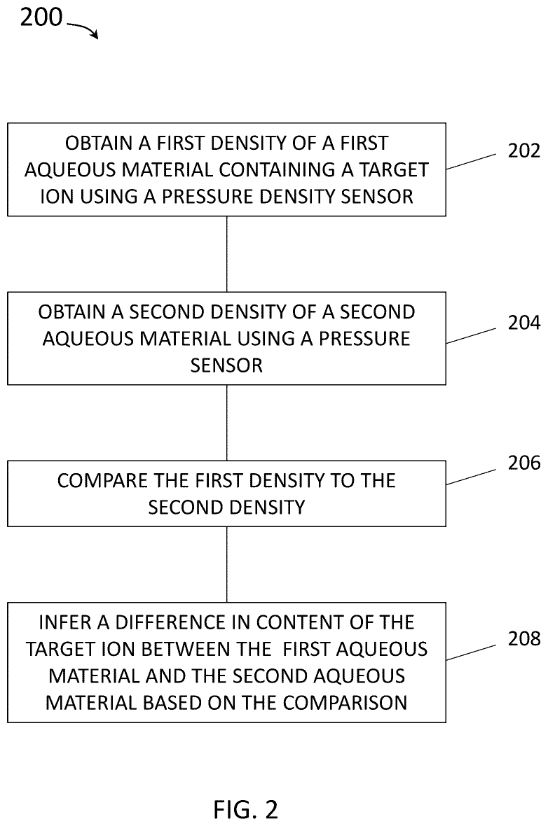

A density difference between two aqueous materials can be used to infer a difference in ion content. FIG. 2 is a flow diagram summarizing a method 200 according to one embodiment. The method 200 can be used to obtain a difference in ion concentration between two aqueous materials. At 202, a first density of a first aqueous material containing a target ion is obtained using a pressure density sensor, such as the pressure density sensors 100 and 150.

At 204, a second density of a second aqueous material is obtained using a pressure density sensor. The same pressure density sensor can be used, or a different pressure density sensor can be used. That is, the first aqueous material can be provided to a vessel having a pressure density sensor to obtain one or more first density readings, and then the first aqueous material can be removed from the vessel. Thereafter, the second aqueous material can be provided to the vessel to obtain one or more second density readings. In such cases, appropriate flushing capability can be provided, for the vessel and the pressure density sensor, to avoid cross-contamination between samples of the two aqueous materials. Where two different pressure density sensors are used, the two sensors can provide substantially continuous density readings of the two aqueous materials.

At 206, the first density and the second density are compared to ascertain a difference between the densities or a difference in one or more parameters that depend on the densities. The difference in densities can be used to monitor processing of the aqueous materials or to relate the compositions of the materials.

At 208, the comparison is used to infer a difference in metal ion content, for example lithium ion content, between the first aqueous material and the second aqueous material. The ion content of the first and second aqueous materials can be computed, and the difference can also be computed, or the densities themselves can be used as representative of ion content, without actually computing the ion contents, and difference. The method 100 can be useful where a process removes lithium from the first aqueous material to yield the second aqueous material. The comparison can provide a substantially continuous reading of the lithium removal.

Metal ion concentration can be inferred from density, and change in metal ion concentration can be inferred from change in density. If concentration of other species in the first and second aqueous materials that affect density thereof are known, and temperature is known, calibration can be used to infer ion concentration of the first aqueous material from the first density, and of the second aqueous material from the second density. The two concentrations can be compared to understand the change in ion concentration between the two materials. Known solutions of target metal ions, with and without other species that affect density, can be analyzed using the pressure density sensor or sensors to give calibration curves for inferring ion concentration from density readings. The known solutions can have a single metal ion, or more than one metal ion, to build calibration relations that can differentiate changes in density resulting from changes in concentration of different metal ions. Additionally or alternately, other sensors that use other physical principles to detect or infer content of non-lithium or non-target species can be used to detect content of other species that affect the density of the aqueous materials. A second sensor that is not a pressure density sensor can be used with a pressure density sensor to obtain information about content of species other than target ions in the aqueous material so the effect of the other species on the fluid density can be ascertained and compensated. Such sensors may be conductivity sensors, pH sensors, spectrum sensors (e.g. IR or UV transmission spectrum analyzers), electrochemical sensors, optical (e.g. colorimetric) sensors, inertial sensors like Coriolis devices, or a combination thereof.

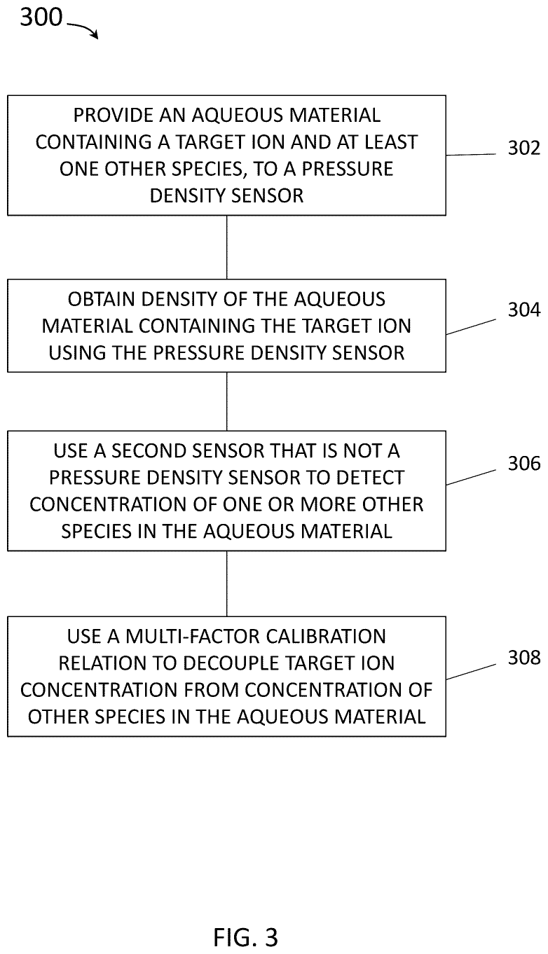

FIG. 3 is a flow diagram summarizing a method 300 according to another embodiment. The method 200 can be used to determine lithium content, or content of other target ions, in an aqueous stream where content of a target ion and other species change with time. At 302, aqueous material containing a target ion, and optionally other species, is provided to a pressure density sensor, such as the pressure density sensors 100 and 150. At 304, density of the aqueous material is obtained using the pressure density sensor, as described above.

At 306, an independent, second sensor that is not a pressure density sensor, for example any of the additional sensors described above, is used to detect concentration of one or more other species in the aqueous material. Where changes in one species that is not the target ion predominate, or where content of all non-target species tend to vary together, or where only one non-target species is present, one additional sensor can be used to detect concentration of non-target species (for instance, chloride). Where changes in more than one non-target species need to be independently decoupled, more than one sensor may be used besides the pressure density sensor. Independent sensors that can be used include conductivity sensors, pH sensors, spectrum sensors (e.g. IR or UV transmission spectrum analyzers), electrochemical sensors, optical (e.g. colorimetric) sensors, inertial density sensors such as Coriolis devices, or a combination thereof. Use of multiple, closely calibrated, and independent sensors, and averaging results can improve accuracy and reduce error. Results from multiple independent sensors detecting the same parameter can allow discovery of error conditions with a sensor so that sensor can be remediated.

At 308, a multi-factor calibration relation is used to decouple concentration of a target ion from concentration of other species. Density readings from the pressure density sensor are calibrated to multiple concentrations of target and non-target species, at different temperatures, to build the multi-factor calibration relation. When the multi-factor calibration relation is reduced to an equation relating density with target ion concentration and concentration of other species, concentration of non-target species detected by a sensor that is not a pressure density sensor can be substituted into the equation, and target ion concentration can be calculated from density readings of the pressure density sensor. As noted elsewhere herein, the target ion here can be lithium, or another metal ion. The other species that can affect density include other metal ions and other soluble and non-soluble materials in the aqueous stream, such as anions and organic ions or molecules.

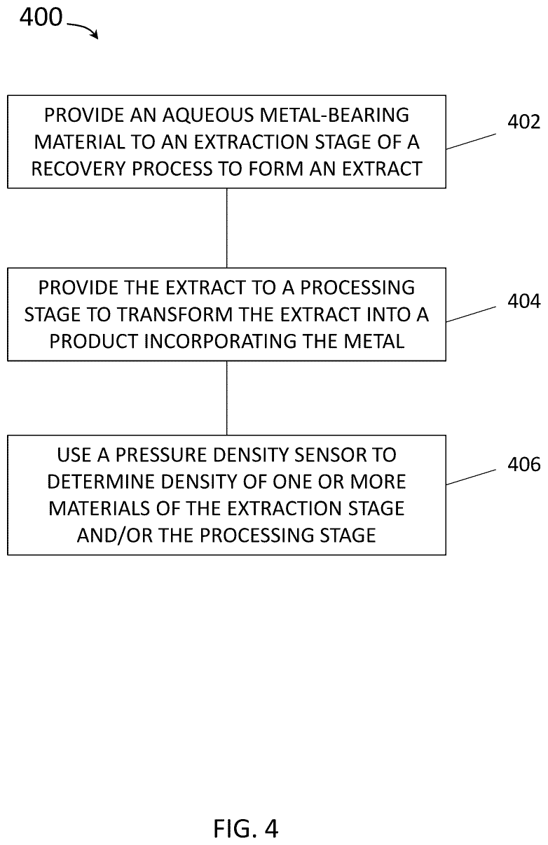

Pressure density sensors can be used in metal recovery operations. FIG. 4 is a flow diagram summarizing a method 400 according to another embodiment. The method 400 is a method of recovering a target metal from an aqueous metal-bearing source containing the target metal.

At 402, an aqueous metal-bearing material is provided to an extraction stage for recovery of the metal. The aqueous metal-bearing material is obtained from a source, which can be a surface source, such as a salar lake or a generated source (i.e. from washing metal containing solid materials); a subterranean source, such as water produced from mines and wells; an industrial source, such as an aqueous byproduct stream, an ocean source, or any other aqueous source containing the target metal. The source may be a solid or liquid material. For example, the aqueous metal-bearing material may be obtained directly from a salar lake, or may be obtained by water washing of a metal-bearing solid material. The metal herein may be lithium.

The extraction stage uses any suitable method of extracting the metal from the aqueous metal-bearing material to form an aqueous extract. The extraction stage can use any form of direct extraction.

In an embodiment, the extraction stage is an ion withdrawal stage, in which an aqueous metal-bearing material (or extraction feed) is contacted with a selective withdrawal medium to withdraw target metal ions from the aqueous metal-bearing material into the selective withdrawal medium, which may be a liquid or a solid. The extraction stage may include Counter-Current Adsorption Desorption (CCAD) processing. Solid selective withdrawal media for withdrawing lithium ions from an aqueous metal-bearing material, such as a resin treated, coated, or impregnated with materials such as aluminum hydroxide, manganese oxide, or titanium oxide can be used. Phosphorus-based liquid lithium-selective media, such as the LiSX™ solvent extraction medium available from Tenova SpA of Castellanza, Italy, or the CYANEX® 936P extractant available from Solvay S.A. of Brussels, Belgium, can also be used. Other effective liquid extractants have also been reported, such as 3-benzoyl-1,1,1-trifluoroacetone dissolved in 1-ethyl-3-methylimidazolium bis(trifluoromethylsulfonyl)imide.

When the selective withdrawal medium is loaded with target ions, an eluent (or recovery stream) is used to remove the target ions from the selective withdrawal medium to form an extract. Concentration of target ions in the extract can be varied and controlled by adjusting a flow rate of the eluent used to remove target ions from the selective withdrawal medium. The flow rate can be adjusted to achieve a desired concentration of target ions in the extract. In the context of a liquid selective withdrawal medium, mixing of any convenient sort can be applied during loading and unloading of the selective withdrawal medium.

In another embodiment, the direct extraction may include electrochemical separation. The selective electrochemical separation process uses a voltage bias to drive materials through a lithium selective membrane to separate lithium from an aqueous lithium source. An example of electrochemical separation is described below.

In this embodiment, the extraction feed and the recovery stream are brought into contact with opposite sides of a selective membrane selective to the metal ions of interest, and a voltage bias is applied across the membrane to perform direct extraction of metal ions from the extraction feed. Metal ions therefore transport across the membrane from the extraction feed to the recovery stream while the extraction feed is in contact with the first side of the membrane and the recovery stream is in contact with the second, opposite, side of the membrane while the electric field enhances the ion transport.

Other electrochemical separation methods may be used as part of the current disclosure, as well other direct extraction methods. For instance, in an embodiment, the extraction feed first circulates under a first voltage of a predetermined polarity in a cell between two electrodes and a membrane that is close to or attached to one of the electrodes so that the selective membrane captures the metal ions and the recovery feed circulates afterwards in the cell under a second voltage having reverse polarity compared to the first voltage, so that the selective membrane releases the captured ion in the recovery stream.

At 404, the extract is provided to a processing stage to transform the extract into a product incorporating the extracted metal. In a lithium context, the product can be a concentrate, for example a concentrated lithium chloride solution or slurry or a lithium carbonate solution or slurry, for further processing and/or purification, or the product may be a battery raw material such as a lithium hydroxide solution, slurry, or solid. The processing stage can use one or more of a concentration process (i.e. increasing the total dissolved solids), a purification process (i.e. decreasing the ratio of impurity to element of interest), or a conversion process (converting a first product including the element of interest to a second product including the element of interest, for instance lithium chloride to lithium hydroxide). A concentration process can involve evaporation, for example flashing or other vaporization processes, membrane separation, including reverse osmosis, osmotically assisted reverse osmosis, nanofiltration, membrane distillation, etc., to remove water from the extract to form a concentrate. The purification process may include precipitation, filtration, chemical reaction, impurity ion withdrawal, or a combination thereof. For instance, as an example, it can include coagulation-flocculation and filtration and then ion exchange for remove divalent ions. The conversion process typically uses a reagent to react with the target ions in the extract, or another stream such as a concentrate stream, to form the lithium product.

In one embodiment, an extract is provided to a concentrator that removes water from the extract by membrane separation, for instance reverse osmosis and/or counter-flow reverse osmosis and/or osmotically assisted reverse osmosis. The concentrate is provided to a conversion process that converts the lithium in the concentrate to lithium hydroxide, either via a lithium carbonate intermediate, or directly to lithium hydroxide in an electrochemical process.

The processes of the processing stage may form solids. For example, concentration may result in salts of the target ions precipitating if the solubility limit of the salts are reached. In another example, a conversion may add ions that preferentially precipitate one or more salts of the target ions having lower solubility, forming solids. In any solids-forming process, the processing stage can include solids handling and removal processes, such as filtration or cyclonic processes, to capture and control solids that may be formed in the processing stage. Such solid removal may be part of the purification process. Other processing stages that can be used, instead of or in addition to, the examples described above include ion exchange units, adsorption/desorption units, filtration units, membrane separation units, and moving bed or simulated moving bed units.

At 406, a pressure density sensor like the pressure density sensors 100 and 150 is used to determine density of one or more materials of the extraction stage and/or the processing stage. The material may be any or all of the aqueous metal-bearing source, the extract, or any other stream of any embodiment of the process, such as the eluent, the depleted stream, the concentrate stream, the product stream, and any byproduct streams. In one example, a water stream is obtained from the processing stage and routed to the extraction stage for use as an eluent or a diluent. A pressure density sensor can be used to determine density of the water stream and one or more parameters of the processing stage can be adjusted based on the density of the water stream. A pressure density sensor can also be used to determine density of other streams of the extraction and processing stages to compare the readings and infer changes in target ion concentration at different locations. The extraction stage and/or the processing stage can be operated based on the readings from the pressure density sensors.

In the method 400, where concentrations of non-target species can change enough to affect the density, a sensor that is not a pressure density sensor can be used, as described above, to sense concentration of one or more non-target species to provide, or improve, target ion concentration detection. A pressure density sensor can be co-located with a second sensor, and signals from both sensors routed to a controller to decouple the concentrations of target and non-target species, which can both be reported and separately controlled.

The methods 200 and 300 can be used with the method 400 to operate the recovery process. In one case, a pressure density sensor is used to determine density, or target ion concentration, of a depleted stream of a direct extraction process resulting from withdrawal of target ions from an aqueous metal-bearing source into a solid selective withdrawal medium. Using a pressure density sensor allows substantially continuous measurement of density, or target ion concentration, in the depleted stream, which can, in turn, enable substantially continuous monitoring of target ion loading in the selective withdrawal medium. Ion concentration in the depleted stream can be monitored, and rise in ion concentration that cannot be attributed to a change in flow rate or to ion concentration of the aqueous metal-bearing material, can be understood as decreasing ion loading of the selective withdrawal medium resulting in incipient breakthrough of ions to the depleted stream. Depending on the ion concentration in the depleted material, contacting the aqueous metal-bearing material with the selective withdrawal medium can be discontinued if the ion concentration indicates an endpoint has been reached. Alternately, or additionally, a pressure density sensor can be used to monitor density, or ion concentration, of the aqueous metal-bearing source, or a material obtained from the aqueous metal-bearing source and provided to the direct extraction process. The density readings of the aqueous metal-bearing source and the depleted material can be used to infer a change in ion concentration due to withdrawal of target ions into the selective withdrawal medium. The direct extraction process can be monitored and operated based on the substantially continuous readings of density and/or ion concentration, and differences in the readings.

Use of a second sensor that is not a pressure density sensor to measure density changes can be used to check, control, and calibrate pressure density sensors to provide reliable, substantially continuous, density readings. The controllers described herein can be configured to receive a calibration signal to update calibration of any of the pressure sensors and/or pressure density sensors described herein. For example, the controllers can be configured to apply a calibration relation to ascertain density from pressure signals. A density reading obtained using a second sensor that is not a pressure density sensor can be provided to a controller, which can be configured to compare the received density reading with a density reading computed based on the coupled pressure sensor or sensors, and to adjust the calibration relation based on the received density reading and the computed density. Such calibration can be automated such that the controller automatically recalibrates every time a density reading is received, or upon receiving a predetermined number of density readings taken using a second sensor that is not a pressure density sensor.

When the selective withdrawal medium is loaded with target ions, as indicated by target ions beginning to break through the selective withdrawal medium to the depleted stream, flow of the aqueous metal-bearing material to the selective withdrawal medium can be discontinued, and an eluent can be contacted with the selective withdrawal medium to remove the target ions from the selective withdrawal medium, thus forming the extract.

A similar process of determining target ion concentration of the extract can be used to determine when the selective withdrawal medium has been unloaded to the extent that removal of target ions from the medium is slowing. Target ions concentration of the extract and the eluent can be determined as described herein, using a pressure density sensor, and optionally a second sensor for non-target species. When target ion concentration in the eluent compared with target ion concentration in the extract indicates target ion removal from the selective withdrawal medium is slowing, flow of the eluent to the selective withdrawal medium can be discontinued, and flow of the aqueous metal-bearing material restarted for a new cycle. The pressure density sensors can be repeatedly used in this way to detect loading and unloading endpoints.

The various endpoints described above can be defined by comparison to standards. For example, target ion concentration in the depleted stream can be compared to a standard to determine whether an endpoint has been reached. Alternately, or additionally, difference in density can be compared to a standard to identify the endpoint. In one method, when target ion concentration in the depleted stream rises to or above a standard target ion concentration value, or approaches the standard, flow of the aqueous metal-bearing material to the selective withdrawal medium can be discontinued and flow of the eluent started. Likewise, when target ion concentration in the extract falls to or below a standard target ion concentration value, or approaches the standard, where the standard for the depleted stream is a first standard and the standard for the extract is a second standard, flow of the eluent to the selective withdrawal medium can be discontinued and flow of the aqueous metal-bearing material can be restarted. In another method, when absolute value of a difference in density between the aqueous metal-bearing material and the depleted material falls to or below a density difference standard, or approaches the density difference standard, flow of the aqueous metal-bearing material to the selective withdrawal medium can be discontinued and flow of the eluent started. Likewise, when absolute value of a density difference between the eluent and the extract falls to or below a density difference standard, or approaches the density difference standard, flow of the eluent can be discontinued and flow of the aqueous metal-bearing material restarted. In this case, the same density difference standard can be used during the loading and unloading phases, or different density difference standards can be used for the two phases.

The substantially continuous monitoring of density described herein by using pressure density sensors provides the ability to monitor loading capacity of the selective withdrawal medium. If a pressure density sensor is used to monitor density of the aqueous metal-bearing material and the depleted aqueous material, the difference in density between the materials can indicate that loading capacity of the selective withdrawal medium is falling as the medium collects target ions. If target ion concentration is determined, for example using sensors other than pressure density sensors to report concentration of non-target species, and if flow rate of one or both streams is known, then an actual mass-loading of target ions within the selective withdrawal medium can be calculated. The density evolution and/or mass-loading of each cycle can be archived for analysis, and a decline in mass-loading per cycle, or mass-loading per cycle reaching or approaching a minimum standard, can indicate that regeneration of the selective withdrawal medium is needed. The same approach may be applied to mass-unloading by monitoring density of the extract and the eluent. Regeneration of some selective withdrawal media can be performed by exposure to hot water and/or hot gas, which can be done by flowing through the selective withdrawal medium, soaking the selective withdrawal medium in quiescent hot water, or both. Other media can be regenerated by exposure to reagents that remove metal ions. Alternately, or additionally, loading and unloading cycle time can be monitored for indications that regeneration is needed. Decreasing cycle time, or cycle time reaching or approaching a minimum standard, can indicate that a regeneration cycle should be started.

In some cases, a direct extraction process uses a plurality of extractors, each having a selective withdrawal medium for contacting with an aqueous metal-bearing material. Pressure density sensors can be used to monitor operation of each extractor or of a set of extractors to determine when each extractor reaches a loading endpoint and an unloading endpoint by substantially continuous reporting of density and/or target ion concentration of the input and output streams of each extractor.

In the case of a liquid selective withdrawal medium, the pressure density sensors described herein can be used to detect the loading of metal ions in the selective withdrawal medium itself, using the methods described herein. The pressure density sensor, engages with the liquid selective withdrawal medium, indicates density of the liquid selective withdrawal medium, which can be related to ion loading in a manner substantially similar to methods described above for monitoring loading of a solid selective withdrawal medium. Change in density of the liquid selective withdrawal medium over time indicates change in composition, and a falling rate of change in density can indicate an endpoint, either of loading or unloading, is approaching.

Substantially continuous monitoring of density and/or target ion concentration in streams of the extraction stage can also be used to optimize extraction performance. Any or all of temperature, pressure, flow rate, pH, cycle time, residence time, moving speed of the selective withdrawal medium in a moving bed or simulated moving bed application, or other parameters may be adjusted depending on density, change in density over time, difference in density between two or more materials, target ion concentration, change in target ion concentration, rate of change of target ion concentration, distance from an endpoint, cycle time, mass-loading of the selective withdrawal medium, or trend thereof.

As noted above, pressure density sensors can be used for substantially continuous monitoring of density and/or target ion concentration in any stream of a recovery process. For example, in a concentration process where target ion concentration is increased in an aqueous material to yield a concentrate, density and/or target ion concentration in a concentrate stream can be monitored and operation of the concentration process adjusted to optimize or improve performance of the concentration process. Thus, temperature, pressure, flow rate, residence time, or other parameters can be adjusted to achieve a target composition of the concentrate. Alternatively, the stream may go through the concentration process a second time. Likewise, pressure density sensors can be used to monitor performance of a conversion process that converts a material containing a target ion to a product. Because the conversion process involves changing compositions of many species, different types of sensors, including pressure density sensors, can be used to monitor multiple species, while pressure density sensors are used to monitor density and/or target ion concentration in streams of the conversion process. Using such sensors, conversion of ions in a feed to the conversion process can be monitored substantially continuously and operation of the conversion process can be adjusted to optimize or improve results.

The pressure density sensors may be used to determine the concentration of total dissolved solids. Where a metal ion of interest is the primary species in an aqueous material and concentration of other species is much lower than concentration of lithium, density changes in the aqueous material can be primarily attributed to changes in metal ion of interest (for instance, lithium) concentration to at least a first approximation. In such cases, a calibration relation or a model can be used to calculate metal ion of interest concentration from density readings. Where other (for instance, non-lithium) species are removed from an aqueous stream as part of a lithium recovery process, for example using chemical reagents to remove impurities such as sodium, calcium, magnesium, and the like, the resulting stream may have sufficient preponderance of lithium to allow direct determination of target ion concentration from density with fair accuracy. In other cases, as described elsewhere herein, independent sensors that are not pressure density sensors can be used to directly detect concentration of non-lithium species in the aqueous material to decouple the effects of lithium and other species on density changes.

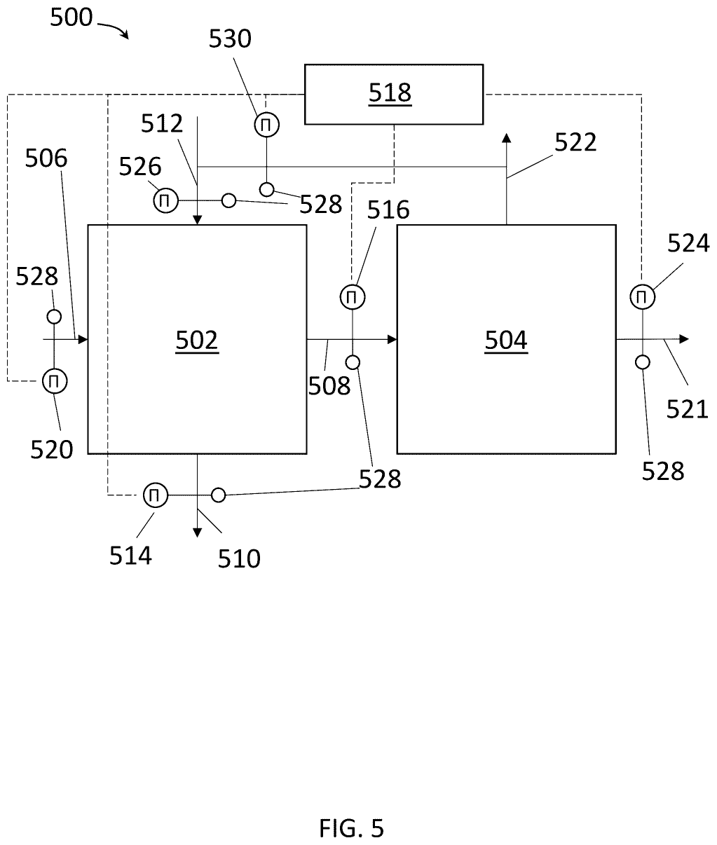

FIG. 5 is a process flow diagram of a recovery process 500, according to one embodiment. The recovery process 500 uses pressure density sensors, such as the pressure density sensors 100 and 150, to provide substantially continuous density and/or target ion concentration readings for multiple metal-bearing streams, and a controller adjusts the process 500 based on the readings, among other signals. The recovery process 500 can be used to recover metals like lithium from aqueous metal-bearing sources.

The recovery process 500 has an extraction stage 502 and a processing stage 504. The extraction stage 502 extracts target ions from an aqueous metal-bearing material 506 to yield an extract 508 and a depleted material 510. In the embodiment of FIG. 5, the extraction stage 502 uses ion withdrawal with a solid selective withdrawal medium, so an aqueous eluent 512 is provided to the extraction stage 502 to unload target ions from the medium. The selective withdrawal medium withdraws target ions from the aqueous metal-bearing material to form the depleted material and the eluent desorbs the target ions from the loaded selective withdrawal medium in an unloading process to yield the extract 508.

A first pressure density sensor 514 is coupled to the depleted material 510, and a second pressure density sensor 516 is coupled to the extract 508, to provide substantially continuous readout of density and/or target ion concentration so that loading and unloading of the selective withdrawal medium can be tracked. A controller 518 is operatively coupled to the first and second pressure density sensors 514 and 516 and to the extraction stage 502 to control operation of the extraction stage 502, for example loading and unloading start and stop and operating parameters like temperature, pressure, flow rate, and moving speed in the case of a moving bed or simulated moving bed application, based on signals from the pressure density sensors 514 and 516.

The controller 518 can be configured to interpret signals from the pressure density sensors 514 and 516 to resolve density and/or target ion concentration in the depleted material 510 and the extract 508. Alternately or additionally, the pressure density sensors 514 and 516 may be configured with computing capability to calculate density and/or target ion concentration of the depleted material 510 and the extract 508, using a calibration relation and/or using signals from other sensors, as described above, so that signals received by the controller 518 from the pressure density sensors 514 and 516 represent density of the respective materials.

An optional third pressure density sensor 520 can be coupled to the aqueous metal-bearing material 506, and operatively coupled to the controller 518, to provide substantially continuous readout of density and/or target ion concentration in the aqueous metal-bearing material 506, so that composition in the various streams can be compared and balanced to understand performance of the extraction stage 502. For example, as noted above, the controller 518 can be configured to compute and track parameters such as mass-loading of the selective withdrawal medium, loading and unloading cycle time, and comparison to standards.

The processing stage 504 transforms the extract 508 into a product 521 and one or more byproducts (here a byproduct 522). In the context of recovering lithium, depending on the operations performed in the processing stage 504, the product 521 may be a lithium chloride product, a lithium carbonate product, a lithium hydroxide product, or a mixture. In one case, the processing stage 504 has a concentrator that removes water from the extract 508 to yield a concentrate and a water stream. The byproduct 522 may be, or may include, the water stream. An optional fourth pressure density sensor 524 is coupled to the product 521, and operatively coupled to the controller 518, to provide substantially continuous readings of density and/or target ion concentration in the product 521. The fourth pressure density sensor 524 may be configured and calibrated based on the composition of the product 521, whether a lithium chloride product, a lithium carbonate product, a lithium hydroxide product, or a mixture thereof, or other metal products. The processing stage 504 can also include a conversion unit to convert the ions in the extract 508, the concentrate produced by the concentrator, or both in any mixture, into the product 521. For example, the conversion unit may use sodium carbonate to convert lithium chloride to lithium carbonate. In such a case, the byproduct 522 will include sodium, and can be characterized as primarily a sodium chloride stream. In another example, lithium carbonate can be converted to lithium hydroxide by reaction with calcium oxide or calcium hydroxide. In such a case, the byproduct 522 will include calcium, which may precipitate as calcium carbonate.

Optionally, a fifth pressure density sensor 526 can be coupled to the eluent 512, and operatively coupled to the controller 518, to determine density and/or target ion concentration of the eluent 512. As described above, density of the eluent can be compared with density of the extract 508 to monitor unloading of lithium ions from the selective withdrawal medium of the extraction stage 502 and to determine when the unit can be switched from unloading to loading mode by discontinuing flow of the eluent and restarting flow of the aqueous metal-bearing material 506. Parameters related to performance of the selective withdrawal medium like extent of mass-loading and -unloading can also be determined and tracked to determine when the selective withdrawal medium needs to be regenerated, for example when a degree or amount of mass-loading before the selective withdrawal medium stops withdrawing target ions from the aqueous metal-bearing material falls to near, at, or below a standard, or when a degree or amount of mass-unloading before the selective withdrawal medium stops releasing target ions to the eluent falls to near, at, or below a standard.

Where appropriate and useful, some or all of the byproduct 522 can be routed to the extraction stage 502 for use as, or with, the eluent 512. An optional sixth pressure density sensor 530 can be coupled to the recycled portion of the byproduct 522, and operatively coupled to the controller 518, to determine density and/or target ion concentration of the recycled portion of the byproduct 522 to control composition of the eluent 512. In some cases, a small concentration of target ions in the eluent 512 can be helpful to performance of the extraction stage 502. The controller 518 can be configured to adjust flow rates of the eluent 512 and the recycled portion of the byproduct 522, based on density and/or target ion concentration determined by the fifth pressure density sensor 526, the sixth pressure density sensor 530, or both, to target a composition of the eluent 512 for best results in the extraction stage 502.

The process 500 uses pressure density sensors to provide substantially continuous readings of density and/or target ion concentration in one or many materials of the process 500. Materials other than the materials indicated in FIG. 5 can be monitored using pressure density sensors. For example, multiple feed streams and eluent streams of the extraction stage 502 can be monitored if the extraction stage contains multiple extraction units. Multiple materials of the processing stage 504, such as concentrate streams, converted streams, and streams separated in the processing stage 504 such as byproduct streams, can also be monitored using pressure density sensors. The controller 518 can be configured and operatively coupled to all the pressure density sensors to control multiple aspects of the operation of the process 500 to achieve desired results in the product 521, or desired operating profiles of the process 500, such as energy efficiency and environmental impact. As an example of the latter, the controller 518 can be configured to adjust flow rate of the depleted material 510 to the environment or to remediation before being returned to the environment, based on density and/or target ion concentration determined by the first pressure density sensor 514.

Where necessary, a second sensor 528 can be co-located with, or coupled to the same material as, each pressure density sensor of the process 500, to provide independent detection of other species in each material that may affect changes to the density of the material, so those effects can be decoupled. The second sensor 528 can, in each case, be configured to detect concentration of a particular non-target species in the respective stream, or to detect concentration of a plurality of non-target species. The controller 518 can be configured to, and operatively coupled with, the second sensors 528 to receive signals representing species to be detected by each second sensor 528 and to decouple concentration of such species from target ion concentration using a multi-factor calibration relation, as described above. The second sensors 528 can be any of the sensors that are not pressure density sensors described above. Alternately, in some cases, the second sensors 528 can be pressure density sensors calibrated to respond to non-target species, if the density effect of such species can be satisfactorily calibrated in a pressure density sensor.

It should be noted that, where a single controller is operatively coupled to more than one pressure density sensor, accuracy of comparing readings from the plurality of pressure density sensors can be improved. For example, the same calibrant fluid can be used to calibrate more than one pressure density sensor, operatively coupled to a single controller, at the same time, and the controller can be calibrated to remove any bias between the readings from the pressure density sensors. In this way, accuracy of differential density measurements using pressure density sensors can be improved.

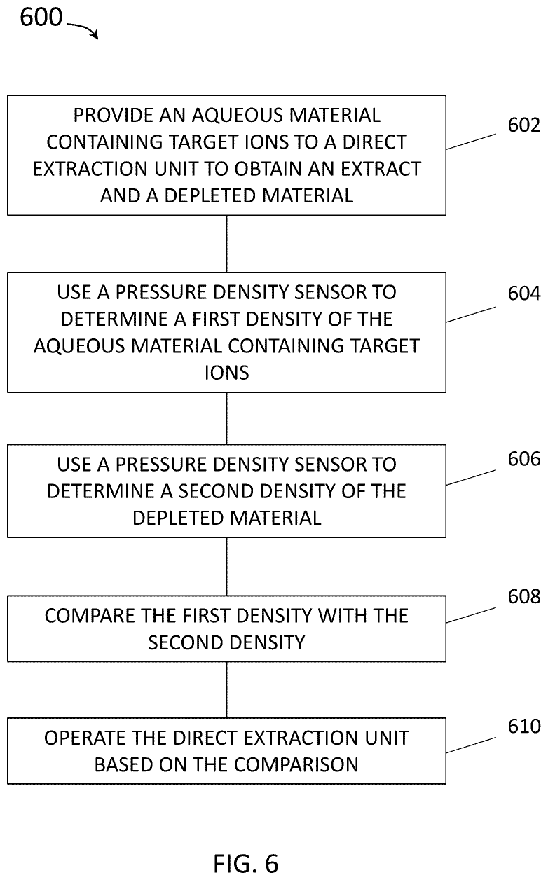

In some cases, operation of a recovery process can be controlled using density determined by a pressure density sensor without resolving target ion concentration from the density. FIG. 6 is a flow diagram summarizing a method 600, according to one embodiment. The method 600 is a method of operating a direct extraction unit. At 602, an aqueous material containing target ions is provided to a direct extraction unit to obtain an extract and a depleted material. As described above, a direct extraction unit contacts an aqueous material containing target ions, such as lithium, with a selective withdrawal medium to withdraw target ions from the aqueous material into or onto the selective withdrawal medium, resulting in a depleted aqueous material effluent from the direct extraction unit. Target ions collect in the selective withdrawal medium until an endpoint is reached, for example when the medium has no remaining capacity to withdraw target ions. At that point, flow of the aqueous material containing target ions can be stopped, and an eluent can be contacted with the loaded selective withdrawal medium to remove target ions from the selective withdrawal medium and form a extract. The direct extraction unit thus yields an extract and a depleted stream using the aqueous material containing target ions and the eluent as inputs.

The method 600 uses density change between inputs and outputs of the direct extraction unit to control operation of the unit. At 604, a first density of the aqueous material containing target ions is determined using a pressure density sensor as described above. At 606, a second density of the depleted material is determine using a pressure density sensor. It should be noted that one pressure density sensor can be used to determine the first and second densities, or two different pressure density sensors can be used. Where one pressure density sensor is used, appropriate flushing capability is provided to ensure no cross-contamination occurs when sampling the two materials. At 608, the first and second densities are compared, typically using a digital controller operatively coupled to the pressure density sensor or sensors. The comparison can be a simple difference, a ratio, or a parameter output by a physical model of the direct extraction unit that represents physical properties of the selective withdrawal medium.

At 610, the direct extraction unit is operated based on the comparison of 608. Temperature and pressure of the unit and/or the aqueous feed to the unit can be adjusted. Flow rate and composition of the aqueous feed to the unit can also be adjusted. For example, composition of ionic species within the aqueous material containing target ions can be adjusted based on the comparison, for example if a physical model of the selective withdrawal medium indicates operation can be improved by such adjustment. In another example, pH of the aqueous material containing target ions can be adjusted, and can also be separately monitored using a pH probe. Moving speed of the selective withdrawal medium during the ion withdrawal process, where a moving bed or simulated moving bed configuration of the selective withdrawal medium is used, can also be adjusted. A digital controller is typically used, as in FIG. 5, to adjust operation of the direct extraction unit based on the comparison. The controller receives signals from the pressure density sensor or sensors, along with any other sensors such as temperature, pressure, or composition sensors (i.e. pH sensors, temperature sensors, pressure sensors, conductivity sensors, electrochemical sensors, optical sensors, inertial sensors, and the like), and is configured to perform the comparison of the first and second densities according to any convenient process and to apply the result to adjust operation of the direct extraction unit.

In another embodiment, operating the direct extraction unit based on the comparison may include determining an endpoint and changing operating mode of the direct extraction unit. As the selective withdrawal medium is loaded with target ions, the incremental amount of target ions removed from the aqueous material containing target ions declines, and the composition, and therefore the density, of the depleted material approaches that of the aqueous material containing target ions. Thus, the comparison of the first and second densities can be used to determine when the selective withdrawal medium has become sufficiently loaded with target ions to discontinue flow of the aqueous material containing target ions to the direct extraction unit. After flow of the aqueous material containing target ions is discontinued, an eluent can be provided to the direct extraction unit, and contacted with the loaded selective withdrawal medium, to remove target ions from the selective withdrawal medium and to yield the extract. Likewise, density difference between the eluent and the extract can be used to determine when removal of target ions from the selective withdrawal medium indicates the selective withdrawal medium has been sufficiently unloaded of target ions to discontinue contacting the selective withdrawal medium with the eluent and restart flow of the aqueous material containing target.

A third density of an intermediate aqueous material of the direct extraction unit can also be determined using a pressure density sensor to monitor performance of the direct extraction unit. In some cases, a plurality of density readings can be taken at different locations of the direct extraction unit to monitor change in the rate of loading or unloading at different locations in the direct extraction unit, for instance in the selective withdrawal medium. For example, where flow of aqueous material containing target ions or eluent is linear through the direct extraction unit, a plurality of density readings can be used to monitor rise of fall of loading throughout the bed of the selective withdrawal medium. In such configurations, rise in loading can be expected to be fastest near a feed location of the unit where aqueous material containing target ions first contacts the selective withdrawal medium, and slowest near where depleted material exits the unit. Likewise, fall in loading can be expected to be fastest near where eluent is provided to the unit and slowest near where extract is withdrawn from the unit. Change in the loading profile of the selective withdrawal medium can be ascertained, substantially continuously, by monitoring density of the aqueous material present at a plurality of locations in the direct extraction unit. Thus, density of an intermediate aqueous material of the direct extraction unit can be determined using a pressure density sensor.

In an example embodiment, a density of an aqueous lithium-bearing material, at 35° C., can be 1074.680 kg/m³, and density of the corresponding depleted material, at a temperature between ambient temperature and 35° C., can be 1075.000 kg/m³, for a density difference of 0.320 kg/m³. Density of the eluent, at 80° C., can be 997.443 kg/m³, and density of the corresponding extract, at a temperature between ambient temperature and 80° C., can be 1004.270 kg/m³. As described above, these density differences will change with operation of the extraction unit, and substantially continuous monitoring of the density of the streams using pressure density sensors of sufficient accuracy to allow comparison of the results, can provide good control of an extraction unit.

Thus, a change in target ion concentration in an aqueous medium due to an operation can be detected by detecting a first density of the aqueous material using a pressure density sensor; performing an operation on the aqueous material to change a target ion concentration of the aqueous material; after performing the operation, detecting a second density of the aqueous material using a pressure density sensor; comparing the first density with the second density; and determining a change in concentration of target ions in the aqueous material based on the comparison. Density readings can be of the pressure density sensors can be used with a calibration relation to determine target ion concentration of the aqueous material. As also described above, with respect to any embodiment described herein, a second sensor that is not a pressure density sensor can also be used to detect concentration of a non-target species in the aqueous material. Doing so can improve accuracy of the detected target ion concentration. The second sensor can be a pH sensor, a conductivity sensor, an electrochemical sensor, an optical sensor, a spectrum sensor, an inertial sensor, or another suitable sensor.

The methods and apparatus described herein can be used in a extraction operation by obtaining an aqueous metal-bearing material from a source; contacting the aqueous metal-bearing material with a selective withdrawal medium in a direct extraction unit to withdraw target ions from the aqueous metal-bearing material to the selective withdrawal medium and form a depleted aqueous material; determining a first density of the aqueous metal-bearing material using a pressure density sensor; determining a second density of the depleted aqueous material using a pressure density sensor; comparing the first density with the second density; discontinuing contacting the aqueous metal-bearing material with the selective withdrawal medium based on the comparison; and after discontinuing contacting the aqueous metal-bearing material with the selective withdrawal medium, contacting an eluent with the selective withdrawal medium to remove target ions from the selective withdrawal medium and form a extract. One or more pressure density sensors can also be used to detect a third density of the extract and a fourth density of the eluent. The third and fourth densities can be compared in a second comparison, and contacting the eluent with the selective withdrawal medium can be discontinued based on the second comparison. Target ion concentration of the extract can be determined using the third density and a calibration relation.

A density of an intermediate aqueous material in the direct extraction unit can also be determined using a pressure density sensor. The direct extraction unit usually uses a vessel to bring the aqueous material into contact with the selective withdrawal medium. A stream of aqueous material can be obtained using a port provided in the vessel, for example in a side wall of the vessel, as shown in FIGS. 1A and 1B, and the obtained aqueous material provided to an pressure density sensor to determine the density of the aqueous material withdrawn from the direct extraction unit. In general, one pressure density sensor can be used to determine the various densities (i.e. first, second, third, fourth densities, etc.) mentioned above, or each pressure density sensor can be a different sensor. As described above, where one pressure density sensor is used to determine density of more than one aqueous material, appropriate flushing of the pressure density sensor between readings will reduce cross-contamination of samples.

Target ion concentration of the aqueous metal-bearing material can be determined using a sensor that is not a pressure density sensor to detect concentration of non-target species in the aqueous metal-bearing material, and based on the detected concentration of non-target species and the first density, determining the target ion concentration. Flow rate of the aqueous metal-bearing material can be varied based on comparison of the first and second densities mentioned above.

Pressure density sensors can be used in a method comprising extracting target ions from an aqueous metal-bearing material in an extraction stage to form a extract; transforming the extract into a product in a processing stage; and using a pressure density sensor to control operation of the extraction stage, the processing stage, or both. The extraction stage can use a solid selective withdrawal medium to withdraw target ions from the aqueous metal-bearing material to form a depleted material. In this case, the pressure density sensor is a first pressure density sensor coupled to the aqueous metal-bearing material to determine a first density of the aqueous metal-bearing material, and a second pressure density sensor is coupled to the depleted material to determine a second density of the depleted material. A difference in density between the aqueous metal-bearing material and the depleted material can be used to control operation of the extraction stage, the processing stage, or both. In one case, the extraction stage uses an eluent to remove the target ions from the selective withdrawal medium to form the extract, a third pressure density sensor is used to determine a third density of the eluent, a fourth pressure density sensor is used to determine a fourth density of the extract, and a difference in density between the eluent and the extract is used to control operation of the extraction stage, the processing stage, or both. The processing stage can include a concentrator that removes water from the extract to form a concentrate, and a third pressure density sensor can be coupled to the concentrate to determine density and/or target ion concentration of the concentrate.

Pressure density sensors can be used in a method of extracting target ions, comprising providing an aqueous material containing metal ions to a direct extraction unit; extracting target ions from the aqueous material using a selective withdrawal medium to yield an extract and a depleted material; determining a first density of the aqueous material containing lithium using a pressure density sensor; determining a second density of the depleted material using a pressure density sensor; comparing the first density with the second density; and operating the direct extraction unit based on the comparison. In this case, the pressure density sensor used to determine the first density and the pressure density sensor used to determine the second density can be different sensors or the same sensor. Operating the direct extraction unit based on the comparison can include adjusting a temperature, pressure, flow rate, or composition of the aqueous material containing target ions, or moving speed of the selective withdrawal medium, based on the comparison. Operating the direct extract unit based on the comparison can include discontinuing flow of the aqueous material containing target ions at a time determined based on the comparison, and after discontinuing flow of the aqueous material, flowing an eluent to the direct extraction unit to yield the extract. Operating the direct extract unit based on the comparison can include regenerating the selective withdrawal medium. This method can include determining a third density of an intermediate aqueous material of the direct extraction unit using a pressure density sensor, and can include operating the direct extraction unit based on the third density.

Pressure density sensors can be used in a method of extracting target ions, comprising contacting an aqueous material containing target ions with a selective withdrawal medium in a direct extraction unit to withdraw target ions from the aqueous material containing target ions into the selective withdrawal medium, to load the selective withdrawal medium with target ions, and to form a depleted material; contacting an eluent with the loaded selective withdrawal medium to remove target ions from the selective withdrawal medium and form a extract; determining a first density of the eluent using a pressure density sensor; determining a second density of the extract using a pressure density sensor; comparing the first density with the second density; and operating the direct extraction unit based on the comparison.

Pressure density sensors can be used in a method of extracting target ions, comprising providing an aqueous material containing target ions to a direct extraction unit; extracting target ions from the aqueous material containing target ions using a selective withdrawal medium to yield an extract and a depleted material; using a pressure density sensor to determine a first density of the aqueous material containing target ions; using a pressure density sensor to determine a second density of the depleted material; comparing the first density with the second density; and operating the direct extraction unit based on the comparison.

Pressure density sensors can be used in a method of extracting metal ions from an aqueous source, the method comprising obtaining an aqueous material bearing a target metal ion from an aqueous source; contacting the aqueous material with a selective withdrawal medium in a direct extraction unit to withdraw a target metal ion from the aqueous material to the selective withdrawal medium and form an ion-depleted aqueous material; using a pressure density sensor to determine a first density of the aqueous material; using a pressure density sensor to determine a second density of the ion-depleted aqueous material; comparing the first density with the second density; discontinuing contacting the aqueous material with the selective withdrawal medium based on the comparison; and after discontinuing contacting the aqueous material with the selective withdrawal medium, contacting an eluent with the selective withdrawal medium to remove target metal ions from the selective withdrawal medium and form an extract.

Pressure density sensors can be used in a method of extracting target ions, comprising providing an aqueous material containing target ions to a direct extraction unit; extracting target ions from the aqueous material containing target ions using a selective withdrawal medium to yield an extract and a depleted material; using a pressure density sensor to determine a first density of the aqueous material containing target ions; using a pressure density sensor to determine a second density of the depleted material; comparing the first density with the second density; and operating the direct extraction unit based on the comparison.

Pressure density sensors can be used in a method, comprising using a pressure density sensor to determine a first density of an aqueous material; performing an operation on the aqueous material to change a concentration of a target ion in the aqueous material; after performing the operation, using a pressure density sensor to determine a second density of the aqueous material; comparing the first density with the second density; and determining a change in a concentration of the target ion, or in a parameter representing a concentration of the target ion, or both, in the aqueous material based on the comparison.

While the foregoing is directed to embodiments of the present invention, other and further embodiments of the present disclosure may be devised without departing from the basic scope thereof, and the scope thereof is determined by the claims that follow.

We claim:

1. A method of extracting target ions, comprising:
providing an aqueous material containing target ions to a direct extraction unit;
extracting target ions from the aqueous material containing target ions using a selective withdrawal medium to yield an extract and a depleted material;
using a pressure density sensor to determine a first density of the aqueous material containing target ions;
using a pressure density sensor to determine a second density of the depleted material;
comparing the first density with the second density; and
operating the direct extraction unit based on the comparison.

2. The method of claim 1, wherein each of using a pressure density sensor to determine the first density and using a pressure density sensor to determine the second density is performed by:
disposing the pressure density sensor to measure fluid pressure within a container and detecting a fluid height within the container, or
measuring a differential pressure of a fluid within a container in at least two locations of the container.

3. The method of claim 1, wherein the pressure density sensor used to determine the first density, the second density, or both, is a quartz resonance device.

4. The method of claim 1, wherein operating the direct extraction unit comprises:
discontinuing contacting the aqueous material with the selective withdrawal medium based on the comparison; and
after discontinuing contacting the aqueous material with the selective withdrawal medium, contacting an eluent with the selective withdrawal medium to remove target metal ions from the selective withdrawal medium and form an extract.

5. The method of claim 4, further comprising detecting a third density of the extract using a pressure density sensor and detecting a fourth density of the eluent using a pressure density sensor, comparing the third density with the fourth density in a second comparison, and discontinuing contacting the eluent with the selective withdrawal medium based on the second comparison.

6. The method of claim 5, wherein each of using a pressure density sensor to determine the first density, using a pressure density sensor to determine the second density, using a pressure density sensor to determine the third density, and using a pressure density sensor to determine the fourth density is performed by one of the following:
disposing the pressure density sensor to measure fluid pressure within a container and detecting a fluid height within the container, or
measuring a differential pressure of a fluid within a container in at least two locations of the container.

7. The method of claim 3, further comprising transforming the extract into a product in a processing stage.

8. The method of claim 1, further comprising determining a first target ion concentration from the first density, determining a second target ion concentration from the second density, or both.

9. The method of claim 1, further comprising using at least a second sensor that is not a pressure density sensor to detect concentration of a non-target species in the aqueous material, the depleted material, or both.

10. The method of claim 9, further comprising determining a concentration of the non-target species in the aqueous material and the depleted material, determining a concentration of the target species in the aqueous material based on the first density and the concentration of the non-target species in the aqueous material, and determining a concentration of the target species in the depleted material based on the second density and the concentration of the non-target species in the depleted material.

11. The method of claim 1, further comprising determining a first target ion concentration from the first density, determining a second target ion concentration from the second density, or determining a change in concentration of target ions from the change in density.

12. The method of claim 1, wherein the target ions are lithium ions.

13. A method, comprising:
using a pressure density sensor to determine a first density of an aqueous material;
performing an operation on the aqueous material to change a concentration of a target ion in the aqueous material;
after performing the operation, using a pressure density sensor to determine a second density of the aqueous material;
comparing the first density with the second density; and
determining a change in a concentration of the target ion, or in a parameter representing a concentration of the target ion, or both, in the aqueous material based on the comparison.

14. The method of claim 13, wherein the target ion is lithium.

15. The method of claim 13, wherein the parameter representing the concentration of the target ion is total dissolved solids.

16. The method of claim 13, wherein each of using a pressure density sensor to determine the first density and using a pressure density sensor to determine the second density is performed by disposing the pressure density sensor to measure fluid pressure within a container and detecting a fluid height within the container.

17. The method of claim 13, further comprising using at least a second sensor that is not a pressure density sensor to detect concentration of a non-target species in the aqueous material.

18. The method of claim 13, wherein the operation is an extraction operation, a concentration operation, a purification operation, or a conversion operation.

19. The method of claim 13, wherein the pressure density sensor used to determine the first density, the second density, or both, is a quartz resonance device.

20. A method, comprising:
extracting target ions from an aqueous metal-bearing material in an extraction stage to form an extract;
transforming the extract into a product in a processing stage;
using a pressure density sensor to determine a change in density of the aqueous metal-bearing material; and
controlling operation of the extraction stage, the processing stage, or both, based on the change in density.
